(19) United States
(12) Patent Application Publication
(10) Pub. No.: US 2007/0001452 A1
(43) Pub. Date: Jan. 4, 2007

(54) Fastening system

(76) Inventor: Ian Friel, Strabane (GB)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/410,430

(22) Filed: Apr. 25, 2006

(30) Foreign Application Priority Data
Apr. 25, 2005 (GB) 0508275.5

(51) Int. Cl. F16L 39/00

(52) U.S. Cl. 285/319

(57) ABSTRACT

A fastening system comprising interlocatable male and female components. One of the male and female components comprises a flexible clip biased to adopt a rest state, and the other of the male and female components includes a seat for a portion of said clip. Upon insertion of the body of the male component into the body of the female component in an axial direction, the clip is deflected from its rest state against its bias to create a holding state in which the clip exerts a holding force on the other of the male and female components. Upon relative rotation of the male and female components when in the holding state, said portion of the clip engages with the seat to lock said male and female portions together.

### FIELD OF THE INVENTION

The present invention relates to a fastening device or system.

### BACKGROUND TO THE INVENTION

U.S. Pat. No. 4,683,670 discloses a fastening system for connecting a signboard to a support. The fastening system comprises a mounting member having a groove and a retainer having a projection. The projection and the groove form a bayonet connection when engaged and serve to secure the signboard to the support. U.S. Pat. No. 4,683,670 discloses that the mounting member has a centrally located aperture to allow the sign to be fastened to the support by a fastener such as a screw.

### SUMMARY OF THE INVENTION

According to one aspect, the present invention provides a fastening system comprising a male component and a female component, the male and female components each having a respective body, the body of the male component being shaped and dimensioned to fit into the body of the female component, wherein one of said male and female components comprises a flexible clip biased to adopt a rest state, and the other of said male and female components includes a seat for at least a portion of said clip, and wherein, upon insertion of the body of said male component into the body of said female component in an axial direction, said clip is deflected from its rest state against said bias to adopt a holding state in which said clip engages with said other of the male and female components, and wherein, upon relative rotation of the male and female components when in the holding state, at least said portion of the clip engages with said seat to lock said male and female portions together.

Typically, in the holding state, the clip is biased to exert a holding force on said other of the male and female components. Preferably, said seat comprises a recess or aperture formed in the body of said other of the male and female components.

The seat may include at least one side wall, said at least one side wall and/or said portion of the clip being shaped to cause said portion of the clip to be removed from the seat upon relative rotation of the male and female components by engagement of said at least one side wall and said clip portion.

The seat may include an end wall, said end wall and/or said portion of the clip being shaped to substantially prevent said portion of the clip from being removed from the seat upon relative movement of said male and female components in said axial direction by engagement of said end wall and said clip portion.

The portion of the clip may comprise a projection arranged to project towards the other of said male and female components when said components are fitted together. The body of said other of the male and female components preferably includes a protrusion arranged to engage with said projection upon relative movement of said male and female components in said axial direction from the holding state in order to inhibit separation of the male and female components.

The protrusion may comprise a rib running partially around the body of said other of the male and female components.

In the illustrated embodiments, the protrusion and the seat substantially do not overlap in said axial direction.

In the illustrated embodiments, the body of one or both of said male and female components is substantially cylindrical in shape.

The clip may be formed at least partially from a flexible resilient material. The clip may be integrally formed with said one of the male and female components, e.g. by plastics moulding.

The clip may be provided on said female component and said seat is provided on said male component.

The body of one or both of the male and female components may have a free end, a plurality of indentation forming members being provided on said free end. At least four indentation forming members may be provided on said free end, the members being substantially evenly spaced around said free end.

At least one of said bodies may project from an obverse face of a base, and wherein the reverse face of said base includes a substantially flat surface and/or at least one aperture for receiving a fixing device.

In the illustrated embodiments, the clip conveniently forms part of the body of said one of said male and female components.

In use of the preferred embodiment, when the male and female components initially engage, the clip deflects as it passes over the protrusion located on the other component and holds the components together in a holding state. The assembly can be disengaged from the holding state by the application of an axial force overcoming the positive, or resilient, engagement of the clip and the protrusion. In other embodiments, the holding state may be effected by the force applied by the clip and without the need for the protrusion.

When in the holding state, rotation of one of the components with respect to the other causes the clip to snap fit into the aperture, thus locking the components in place. To release the components, one of the components is rotated with respect to the other to force the clip out of the aperture and back to the holding state, from which the assembly can be disengaged by the application of an axial force.

Both components advantageously comprise a substantially flat base to allow for the application of, e.g., a chemical bond or other fixing agent, to fix the components to the surface of a fixture or fitting, such as a signboard, fascia, sign or sign part. Alternatively, or in addition, a hole provided through each component base provides for the insertion of a mechanical fixing such as a screw.

Further advantageous aspects of the invention will become apparent to those ordinarily skilled in the art upon review of the following description of a specific embodiment and with reference to the accompanying drawings.

### BRIEF DESCRIPTION OF THE DRAWINGS

A preferred embodiment of the invention will now be described by way of example with reference to the accompanying drawings, in which:

FIG. 1 is an isometric view of a male component of a fastening system embodying the invention;

FIGS. 2(a) & (b) are isometric views of a female component cooperable with the component of FIG. 1;

FIGS. 3(a)-(c) show the components of FIGS. 1 and 2 in a holding state; and

FIGS. 4(a)-(c) show the components of FIGS. 1 and 2 in a locked state.

### DETAILED DESCRIPTION OF THE DRAWINGS

Referring now to the drawings, the system comprises a male component 10 and a corresponding female component 20 which are inter-engagable with one another as is described in more detail below. Typically, each component 10, 20 comprises a respective substantially cylindrical body 18, 29. The body 18 of the male component 10 is typically of smaller diameter than the body 29 of the female component 20 such that the male component 10 fits into the female component 20. The male and female components 10, 20 each have a generally solid base 13, 23 from which the respective bodies 18, 29 project.

The body 18 of the male component 10 may include an outwardly projecting interference protrusion or rib 11 which is spaced from the base 13 and runs at least partially around the external surface of the body 18, conveniently in a generally circumferential manner. The body 18 also includes a recess, or preferably an aperture 12, preferably formed adjacent the base 13, or at least between base 13 and the level of the rib 11. In the preferred embodiment, the rib 11 extends only partially around the body 18 and the aperture 12 is substantially aligned with a region of the body around with the rib 11 does not extend.

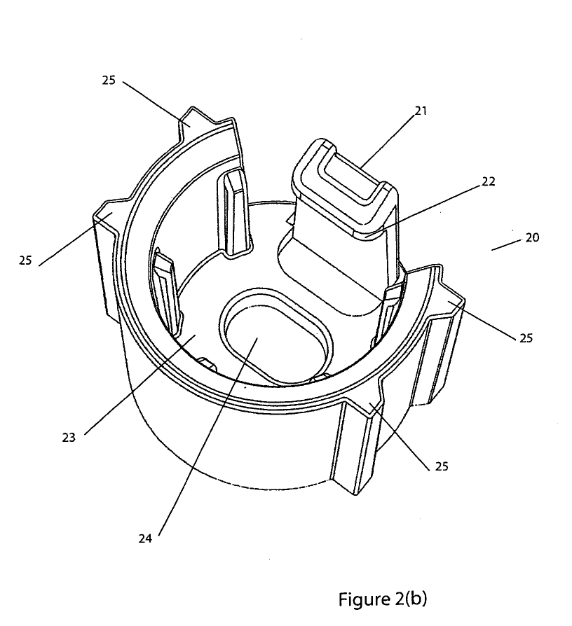

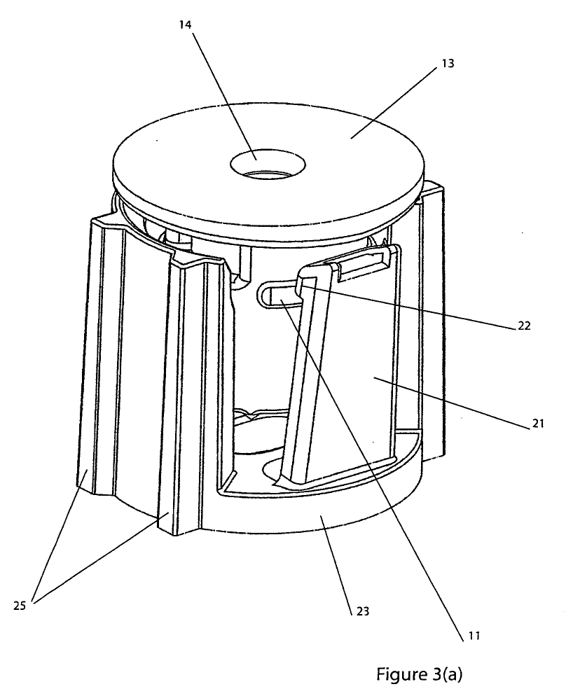

The components 10, 20 may be held together by means of a flexible clip 21 having an inwardly projecting protrusion or nose 22 and, conveniently, forming part of the body 29 or side wall of the female component 20 (or being provided in a gap formed in the body 29). The clip 21 has a rest state (FIG. 2(a)) and exhibits a resilience, or is biased, to return to the rest state if displaced therefrom. Conveniently, the clip 21 has an inherent resilience and is, for example, co-formed with the base 23 by plastics moulding. The nose 22 projects inwardly of the body 29 such that it engages with the body 18 of the male component 10 when the male component 10 is inserted into the female component 20 thus causing the clip 21 to be displaced from the rest state outwardly with respect to the body 29.

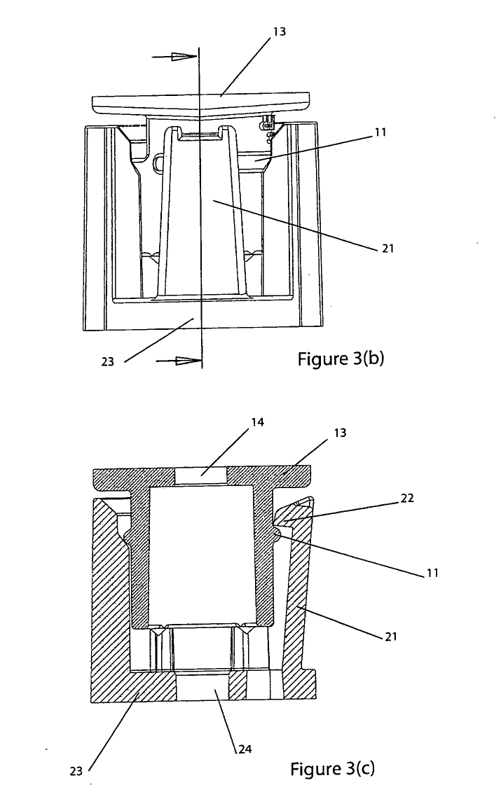

The clip 21 may operate in two modes; firstly, when the male and female components 10, 20 are initially engaged, the clip 21 is displaced outwardly, against its resilience or bias, by the body 18 and subsequently rides over the rib 11. Once the clip 21 is beyond the rib 11, the clip 21 is able to flex back to engage with the outer surface of the body 18 between the rib 11 and the base 13. In this holding state, the clip 21 is under tension and its resilience or bias urges it into contact with the male component 10. This resistance, in conjunction with the engagement of the nose 22 and rib 11 (when present), holds the assembly of male and female components 10, 20 together. Even though the clip 21 and rib 11 are providing resistance, the components 10, 20 can still be disassembled by pulling them apart in the direction of their common axis. Provision of the rib 11, or other protrusion, is preferred since the rib 11 and nose 22 may engage in the holding state (as shown in FIG. 3(c)) and this provides an increased resistance against pulling the components 10, 20 apart from the holding state. In alternative embodiments, the rib 11 may be omitted. In a still further embodiment, the clip is only deflected out of its rest state by the protrusion/rib and so adopts its rest state when in the holding state—in this embodiment, it is the interference between the nose 22 and the rib 11 (or their equivalents) that provides resistance against pulling the components apart from the rest state,

The second mode can be implemented when the two components 10, 20 are in the holding state by relative rotation of the components 10, 20 about their common axis until the nose 22 snaps, under the resilience of the clip, into the window aperture 12 formed in the side wall, or body 18, of the male component 10. This causes the components 10, 20 to adopt a locked state in which they cannot readily be separated by pulling them apart in the direction of their common axis.

To release the two components 10, 20 from the locked state, the female 20 (or the male 10) is rotated either in a clockwise or anticlockwise direction about their common axis, forcing the nose 22 out of the aperture 12 (by engagement with the sides of the aperture) and back under tension against the exterior surface of the body 18, i.e. back to the holding state from which the components 10, 20 can be pulled apart axially. To this end, the nose 22, and/or the walls 15′, 15″ of the aperture 12, are preferably shaped, e.g. rounded, such that engagement of the nose 22 and walls 15′, 15″ during relative rotation of the components 10, 20 causes the nose 22 to be displaced outwardly to an extent that the components 10, 20 may resume the holding state.

In alternative embodiments, the rib 11 may be provided on the inner surface of the outer or female component, the clip 21 being provided on the inner or male component and arranged to flex inwardly upon engagement of the nose with the rib. The aperture 12 may also be provided in the wall of the female component.

There are two preferred attachment options for fixing the components 10, 20 to their respective fixture/fitting (not shown). The respective flat base 13, 23 on the male and female components 10, 20 allows for the application of a chemical bond, while a respective aperture 14, 24 through the base 13, 23 of each of the male and the female 10, 20 allows for a mechanical fixing. For a mechanical fixing, screws (not shown) or other fixing means inserted through the apertures 14, 24 in the male and female components 10, 20. When the system is assembled, the apertures 14, 24 are preferably in register with one another, or at least partially in register with one another.

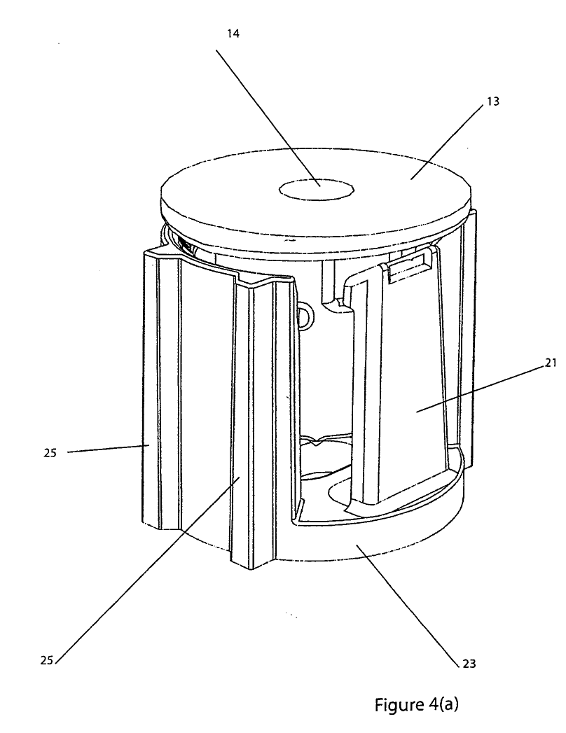

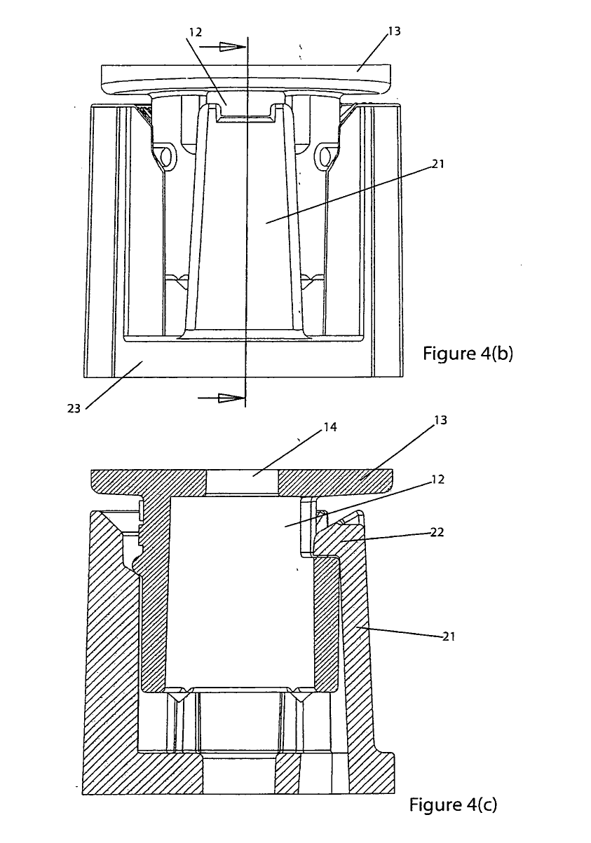

To fit the components 10, 20 together, the male 10 and female 20 are initially engaged (FIG. 3(a)) with the clip 21 riding over the interference rib 11 and holding the two components 10, 20 together as described above. To lock the components 10, 20, the female 20 (typically) is rotated until the clip 21 snaps into the aperture 12 in the male 10 (FIG. 4(a)-(c)).

The window or aperture 12 may lie circumferentially substantially in register with the discontinuity in the projecting rib 11 to allow the clip 21 to properly engage in the aperture 12 when in the locked state. It is also preferred that the walls 15′, 15″ of the aperture 12 running parallel with the longitudinal axis of the component 10 are bevelled to allow the clip 21 to slide out of the aperture 12 when rotated, whereas the bridging wall 16 is preferably straight cut to inhibit or prevent relative axial movement of the components 10, 20 when in the locked state.

The fastening system, or device, of the present invention provides means for fixing, for example, sign/shop fitting products to interior or exterior fixtures such as fascias (although there are numerous other applications).

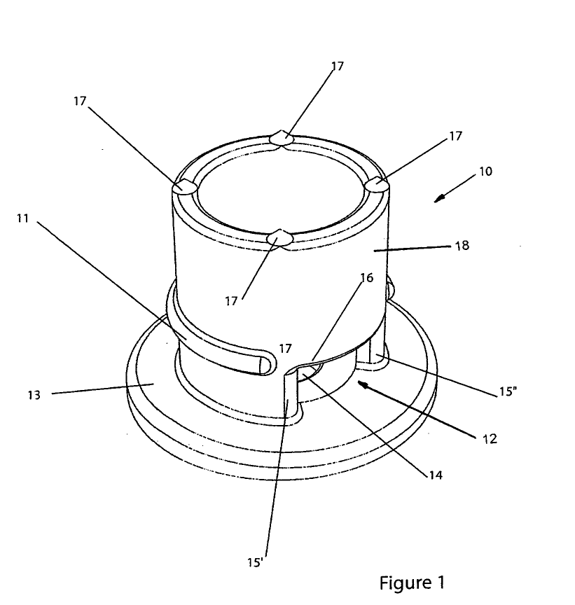

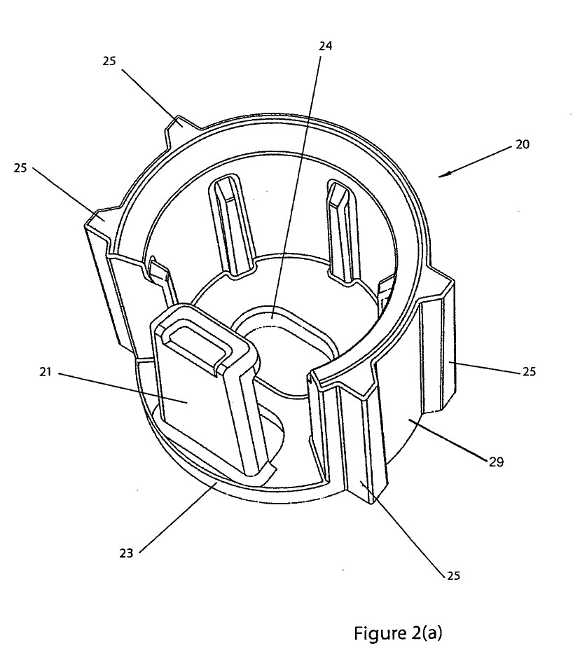

In more detail, referring to FIG. 1, a plurality of, and preferably four, spikes or cone shaped points 17 are advantageously formed on the free edge or end of the body 18 of the male component 10. The points 17 are circumferentially spaced apart, advantageously at regular intervals. The points 17 may be used to identify where a centre hole should be drilled for the mounting of the female component 20. For example, the points 17 may be pressed against a fixture, such as a fascia surface, creating respective indentations. The resulting marks may be diagonally joined up to find their intersection at which point the centre can be marked. This enables a fitting, for example, a sign or letter, to which the male component has been previously fixed to be accurately located on a fascia. Similar spikes or points may alternatively, or in addition, be provided on the body 29 of the female component 20.

Referring to FIG. 2, it will be seen that running along opposite external sides of the female component 20, there are formed a plurality of longitudinal ribs 25 conveniently formed in pairs. These enable the body 29 to be gripped either by hand, or by a tool such as a spanner, located around the female component 20 between the fixture and fitting either to rotationally adjust the fitting or to enable the female component 20 to be rotated out of the locked state into the holding state prior to removal of the fitting from the fixture.

While the embodiment has been described in terms of the male member being fixed to a removable fitting and the female member being fixed to a fixture, the system may equally be employed in reverse.

Conveniently, the male and female components 10, 20 are formed from plastics, and may each be formed as a respective single piece by means of conventional moulding.

The invention is not limited to the embodiment described herein which may be modified or varied without departing from the scope of the invention.

1. A fastening system comprising a male component and a female component, the male and female components each having a respective body, the body of the male component being shaped and dimensioned to fit into the body of the female component, wherein one of said male and female components comprises a flexible clip biased to adopt a rest state, and the other of said male and female components includes a seat for at least a portion of said clip, and wherein, upon insertion of the body of said male component into the body of said female component in an axial direction, said clip is deflected from its rest state against said bias and adopts a holding state in which said clip engages with said other of the male and female components, and wherein, upon relative rotation of the male and female components when in the holding state, at least said portion of the clip engages with said seat to lock said male and female portions together.

2. A fastening system as claimed in claim 1, wherein, in the holding state, the clip is biased to exert a holding force on said other of the male and female components.

3. A fastening system as claimed in claim 1, wherein said seat comprises a recess or aperture formed in the body of said other of the male and female components.

4. A fastening system as claimed in claim 1, wherein said seat includes at least one side wall, said at least one side wall and/or said portion of the clip being shaped to cause said portion of the clip to be removed from the seat upon relative rotation of the male and female components by engagement of said at least one side wall and said clip portion.

5. A fastening system as claimed in claim 1, wherein said seat includes an end wall, said end wall and/or said portion of the clip being shaped to substantially prevent said portion of the clip from being removed from the seat upon relative movement of said male and female components in said axial direction by engagement of said end wall and said clip portion.

6. A fastening system as claimed in claim 1, wherein said portion of the clip comprises a projection arranged to project towards the other of said male and female components when said components are fitted together.

7. A fastening system as claimed in claim 6, wherein the body of said other of the male and female components includes a protrusion arranged to engage with said projection upon relative movement of said male and female components in said axial direction from the holding state in order to inhibit separation of the male and female components.

8. A fastening system as claimed in claim 7, wherein said protrusion comprises a rib running partially around the body of said other of the male and female components.

9. A fastening system as claimed in claim 8, wherein said protrusion and said seat substantially do not overlap in said axial direction.

10. A fastening system as claimed in claim 1, wherein the body of one or both of said male and female components is substantially cylindrical in shape.

11. A fastening system as claimed in claim 1, wherein said clip is formed at least partially from a flexible resilient material.

12. A fastening system as claimed in claim 1, wherein said clip is integrally formed with said one of the male and female components.

13. A fastening system as claimed in claim 1, wherein said clip is provided on said female component and said seat is provided on said male component.

14. A fastening system as claimed in claim 1, wherein the body of one or both of the male and female components has a free end, a plurality of indentation forming members being provided on said free end.

15. A fastening system as claimed in claim 14, wherein at least four indentation forming members are provided on said free end, the members being substantially evenly spaced around said free end.

16. A fastening system as claimed in claim 1, wherein at least one of said bodies projects from an obverse face of a base, and wherein the reverse face of said base includes a substantially flat surface and/or at least one aperture for receiving a fixing device.

17. A fastening system as claimed in claim 1, in which said clip forms part of the body of said one of said male and female components.

18. A fastening system as claimed in claim 7, wherein said protrusion and said seat substantially do not overlap in said axial direction.
